(19) United States
(12) Patent Application Publication
(10) Pub. No.: US 2012/0285374 A1
(43) Pub. Date: Nov. 15, 2012

(54) EVAPORATION SOURCE WITH FLAME JETTING UNIT AND RELATED EVAPORATION DEPOSITION SYSTEM

(75) Inventor: SHAO-KAI PEI, Tu-Cheng (TW)

(73) Assignee: HON HAI PRECISION INDUSTRY CO., LTD., Tu-Cheng (TW)

(21) Appl. No.: 13/167,727

(22) Filed: Jun. 24, 2011

(30) Foreign Application Priority Data
May 12, 2011 (TW) 100116632

(51) Int. Cl. B05C 9/02

(52) U.S. Cl. 118/47

(57) ABSTRACT

An evaporation source includes a crucible chamber, a crucible, a driving unit, a flame jetting unit and an electron-beam emitting unit. The crucible is rotatably received in the crucible chamber, and contains a target material. The driving unit is located on a sidewall of the crucible chamber and drives the crucible to rotate. The flame jetting unit jets a flame to pre-heat the target material in the crucible. The electron-beam emitting unit emits an electron-beam to the crucible to evaporate the pre-heated target material. An evaporation deposition system using the evaporation source is also provided.

### BACKGROUND

1. Technical Field

The present disclosure relates to an evaporation source and an evaporation deposition system using same.

2. Description of Related Art

Evaporation sources are key components for evaporation deposition systems, including for example, electron-beam evaporation deposition systems and ion assisted electron-beam evaporation deposition systems.

A typical evaporation source includes a crucible containing a target material, and an electron-beam emitting unit for emitting an electron-beam for bumping the target material to a substrate to be treated.

However, as the electron-beam momentarily applies great energy on the target material, a plurality of holes will be left on the target material where the electron-beam bumps, thus making the target material uneven. In addition, the great energy of the electron-beam shortly changes the temperature of the target material, producing a blinding light, which makes workers uncomfortable.

What is needed, therefore, is an evaporation source and an evaporation deposition system using same, which can overcome the above shortcomings.

### BRIEF DESCRIPTION OF THE DRAWINGS

Many aspects of the present evaporation source and evaporation deposition system can be better understood with reference to the following drawings. The components in the drawings are not necessarily drawn to scale, the emphasis instead being placed upon clearly illustrating the principles of the present evaporation source and evaporation deposition system. Moreover, in the drawings, like reference numerals designate corresponding parts throughout the several views.

FIG. 1 is an isometric view of an evaporation source in accordance with one embodiment.

FIG. 2 is an exploded view of the evaporation source of FIG. 1.

FIG. 3 is a schematic view of an evaporation deposition system using the evaporation source of FIG. 1, wherein the evaporation source is taken the line shown in FIG. 1.

### DETAILED DESCRIPTION

Embodiments of the present evaporation source and evaporation deposition system will now be described in detail below and with reference to the drawings.

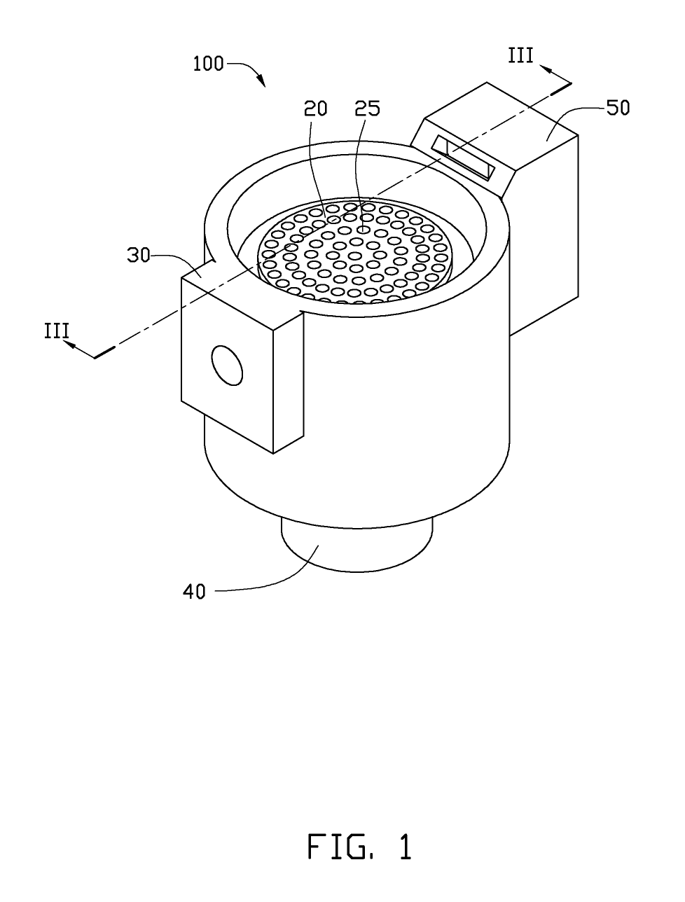

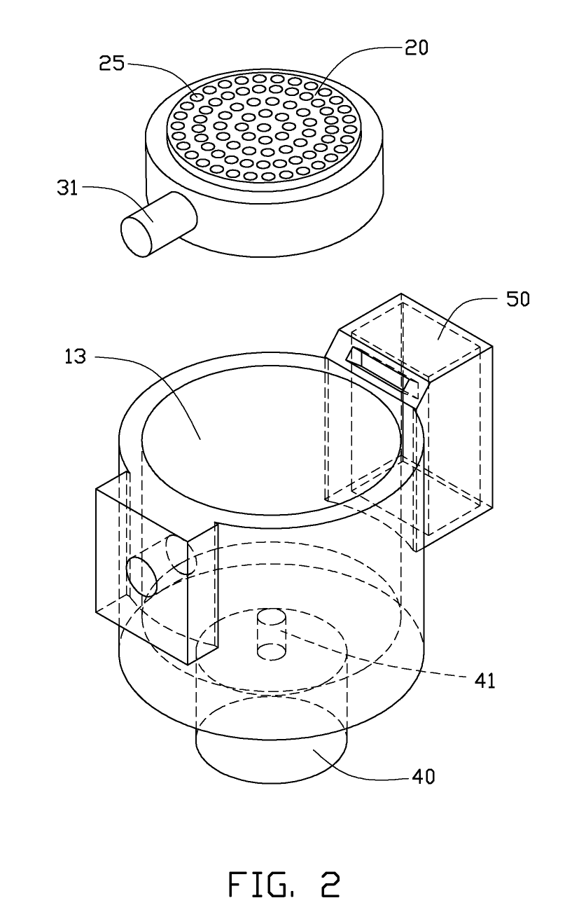

Referring to FIGS. 1 to 3, an evaporation source 100 is used for evaporating a target material to a substrate 201 in an evaporation deposition system 200. The target material can be particles, plates or in other shapes. The evaporation source 100 includes a crucible chamber 13, a crucible 20, a driving unit 30, a flame jetting unit 40 and an electron-beam emitting unit 50.

The crucible chamber 13 is substantially cylindrical, and includes a bottom wall 11 and an annular chamber sidewall 12. The bottom wall 11 and the annular chamber sidewall 12 cooperatively define the crucible chamber 13. That is, the crucible chamber 13 has one end open. In the present embodiment, the crucible chamber 13 is made of stainless steel. In other embodiments, the crucible chamber 13 can also be made of other materials having a high temperature resistance, such as a ceramic material.

The crucible 20 is located in the crucible chamber 13, and defines a receiving space 24, configured for containing a target material. The crucible 20 is substantially cylindrical, and includes a top wall 21, a bottom wall 22 and an annular crucible sidewall 23 interconnecting the top wall 21 and the bottom wall 22. The top wall 21, the bottom wall 22 and the annular crucible sidewall 23 cooperatively define the receiving space 24. The top wall 21 and the bottom wall 22 each define a plurality of air vents 25. The air vents 25 are configured for increasing air exchange to heat the target material evenly, and facilitating the target material to evaporate. A diameter of each of the air vents 25 is smaller than a diameter of the target material.

Alternatively, the crucible 20 can also be in other shapes, such as in a sphere shape.

The crucible 20 is made of copper. In other embodiments, the crucible 20 can also be made of other materials which are thermal conductive and has a high temperature resistance, such as a ceramic material.

The driving unit 30 is located at the annular chamber sidewall 12 of the chamber 13, and includes a driving shaft 31 connected with the crucible 20. The driving unit 30 is configured for driving the crucible 20 to rotate with the driving shaft 31 as an axis. Due to the rotation of the crucible 20 about the driving shaft 31, the crucible 20 can alternatively have the air vents 25 formed only in one of the top wall 21 or the bottom wall 22.

The flame jetting unit 40 is located at the bottom wall 11 of the crucible chamber 13, and includes a nozzle 41 extending through the bottom wall 11. The flame jetting unit 40 is configured for jetting a flame to the crucible 20 through the nozzle 41 to pre-heat the target material in the crucible 20. A temperature of the flame can be determined in the flame jetting unit 40 by controlling the size of the flame.

In the present embodiment, the flame jetting unit 40 jets an oxy-hydrogen flame. The oxy-hydrogen flame is safe and environmental friendly, and especially the oxy-hydrogen flame is good for an oxide evaporation, because it contains oxygen and thus can avoid lack of oxide during the oxide evaporation. In other embodiments, the flame jetting unit 40 can jet other flame suitable for the evaporation of the target material.

The electron-beam emitting unit 50 is also located at the annular chamber sidewall 12 of the crucible chamber 13. In the present embodiment, the electron-beam emitting unit 50 is positioned opposite to the driving unit 30. The electron-beam emitting unit 50 is configured for emitting an electron-beam to the crucible 20 to bump against the pre-heated target material in the crucible 20. In this way, the target material in the crucible 20 can easily be evaporated to deposition on the substrate.

A magnetic deflection field can be applied to the electron-beam to control a direction of the electron-beam. Due to the magnetic deflection field, the position of the electron-beam emitting unit 50 can be selected.

In application of the evaporation source 100, the flame jetting unit 40 is first initiated to pre-heat the target material in the crucible 20, at the same time, the driving unit 30 is operated to rotate the crucible 20 about the driving shaft 31. Then, after the pre-heating, the electron-beam emitting unit 50 is operated to bump the pre-heated target material to the substrate 201 using the emitted electron-beam.

The pre-heating does not need to make the target material molten, and only makes the target material a little softer, such that the electron-beam can easily bump the target material to the substrate, thus holes left in the target material after the bumping can be reduced. As the pre-heated target material is warm, a blinding light can be avoided during the bumping of the electron-beam.

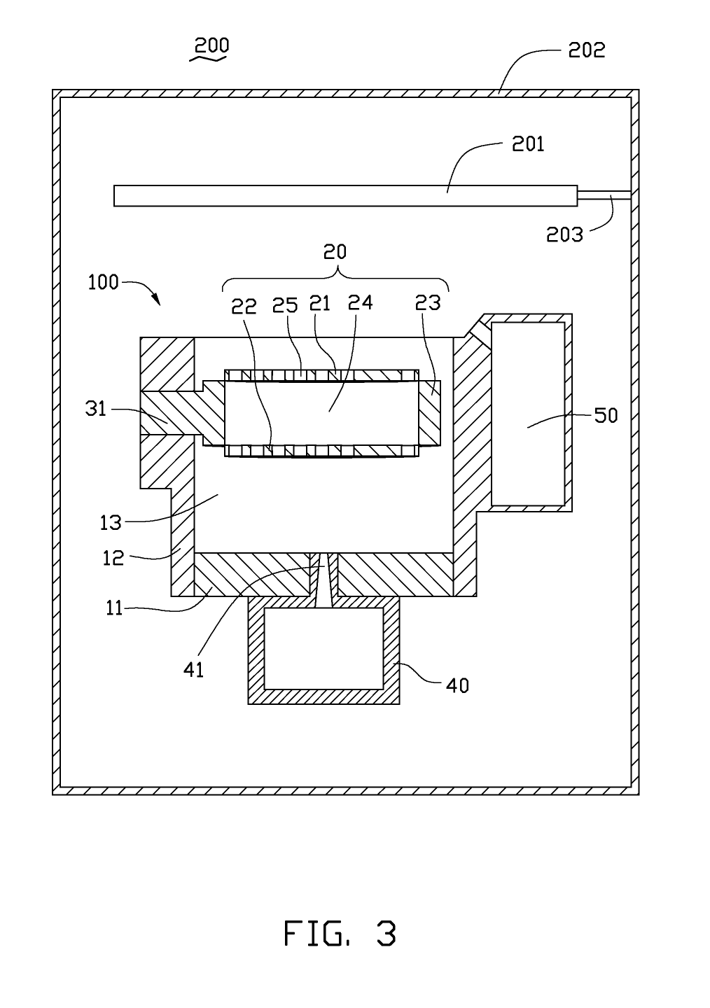

Referring again to FIG. 3, the evaporation deposition system 200 using the evaporation source 100 may further include a deposition room 202 to receive the evaporation source 100 and the substrate 201 therein. The substrate 201 faces the evaporation source 100, and may be rotatably held by a holder 203.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An evaporation source, comprising:
a crucible chamber;
a crucible rotatably received in the crucible chamber, and configured for containing a target material;
a driving unit mounted on a sidewall of the crucible chamber and configured for driving the crucible to rotate;
a flame jetting unit configured for jetting a flame to pre-heat the target material in the crucible; and
an electron-beam emitting unit configured for emitting an electron-beam to the crucible to evaporate the pre-heated target material.

2. The evaporation source of claim 1, wherein the crucible comprises a top wall, a bottom wall and an annular crucible sidewall, the top wall, the bottom wall and the crucible sidewall cooperatively define a receiving space for containing the target material, at least one of the top wall and the bottom wall has a plurality of air vents formed therein, with a diameter of each of the air vents being smaller than a diameter of the target material.

3. The evaporation source of claim 1, wherein the crucible chamber comprises a bottom wall and an annular chamber sidewall, and a top opening.

4. The evaporation source of claim 3, wherein the driving unit is mounted at the crucible chamber sidewall, and comprises a driving shaft connected to the crucible and configured for rotating the crucible about the driving shaft.

5. The evaporation source of claim 3, wherein the flame jetting unit is located at the bottom wall of the crucible chamber, and comprises a nozzle extending through the bottom wall of the crucible chamber.

6. The evaporation source of claim 1, wherein the flame jetting unit is an oxy-hydrogen flame jetting device.

7. An evaporation deposition system, comprising:
a deposition chamber for receiving a substrate; and
an evaporation source received in the deposition chamber, the evaporation source comprising:
a crucible chamber having an opening facing toward the substrate;
a crucible rotatably received in the crucible chamber, and configured for containing a target material;
a driving unit mounted on the crucible chamber and configured for driving the crucible to rotate;
a flame jetting unit configured for jetting a flame to pre-heat the target material in the crucible; and
an electron-beam emitting unit configured for emitting an electron-beam to the crucible to evaporate the pre-heated target material.

8. The evaporation deposition system of claim 7, further comprising a holder rotatably mounted in the deposition chamber, the holder configured for holding and rotating the substrate.

9. The evaporation deposition system of claim 7, wherein the crucible comprises a top wall, a bottom wall and an annular crucible sidewall, the top wall, the bottom wall and the crucible sidewall cooperatively define a receiving space for containing the target material, at least one of the top wall and the bottom wall has a plurality of air vents formed therein, with a diameter of each of the air vents being smaller than a diameter of the target material.
